(19) United States
(12) Patent Application Publication
(10) Pub. No.: US 2016/0127439 A1
(43) Pub. Date: May 5, 2016

(54) INTERFACING MULTIMEDIA PUBLIC WARNING SYSTEM ALERTS

(71) Applicant: QUALCOMM Incorporated, San Diego, CA (US)

(72) Inventors: Vani Chaitanya Ginnela, Hyderabad (IN); Edward Robert Hall, Bristol (GB); Praveen Nagaraja Kona, Hyderabad (IN)

(21) Appl. No.: 14/531,597

(22) Filed: Nov. 3, 2014

(51) Int. Cl. H04L 29/06; H04L 12/58; H04W 4/22

(52) U.S. Cl. CPC H04L 65/601; H04W 4/22; H04L 51/10

(57) ABSTRACT

Interfacing of multimedia public warning system alerts is discussed in which a user equipment (UE) receives a system information broadcast message with a multimedia alert contained therein. The multimedia alert triggers the UE to automatically initiate a multimedia broadcast application to process the alert. The multimedia alert includes broadcast system information that enables the multimedia broadcast application to automatically tune the UE to the streaming multimedia content associated with the alert. The UE may then process the streaming multimedia content on the UE.

### BACKGROUND

1. Field

Aspects of the present disclosure relate generally to wireless communication systems, and more particularly, to interfacing multimedia public warning system (PWS) alerts.

2. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of user equipments (UEs), also referred to as mobile entities. A UE may communicate with a base station via a downlink and an uplink. The downlink (or forward link) refers to the communication link from the base station to the UE, and the uplink (or reverse link) refers to the communication link from the UE to the base station. As used herein, a “base station” means an eNode B (eNB), a Node B, a Home Node B, or similar network component of a wireless communications system.

The 3rd Generation Partnership Project (3GPP) Long Term Evolution (LTE) represents a major advance in cellular technology as an evolution of Global System for Mobile communications (GSM) and Universal Mobile Telecommunications System (UMTS). The LTE physical layer (PHY) provides a highly efficient way to convey both data and control information between base stations, such as an evolved Node Bs (eNBs), and mobile entities, such as UEs. In prior applications, a method for facilitating high bandwidth communication for multimedia has been single frequency network (SFN) operation. SFNs utilize radio transmitters, such as, for example, eNBs, to communicate with subscriber UEs. In unicast operation, each eNB is controlled so as to transmit signals carrying information directed to one or more particular subscriber UEs. The specificity of unicast signaling enables person-to-person services such as, for example, voice calling, text messaging, or video calling.

Recent LTE versions support eMBMS in the LTE air interface to provide the video streaming and file download broadcast delivery. For example, video streaming service is expected to be transported by the DASH (Dynamic Adaptive Streaming using HTTP) protocol over FLUTE (File Delivery over Unidirectional Transport) as defined in IETF RFC 3926 over UDP/IP packets. File download service is transported by FLUTE over UDP/IP protocols. Both high layers over IP are processed by the LTE broadcast channels in PHY and L2 (including MAC and RLC layers). However, such transport includes multiple inefficiencies which are not currently addressed in the communications industry.

### SUMMARY

In one aspect of the disclosure, a method of wireless communication includes receiving, by a user equipment (UE), a system information broadcast message with a multimedia alert, automatically initiating, by the UE, a multimedia broadcast application in response to the multimedia alert, wherein the multimedia alert includes broadcast system information enabling the multimedia broadcast application to automatically tune into a streaming multimedia content, and processing, by the UE, the streaming multimedia content on the UE.

In an additional aspect of the disclosure, an apparatus configured for wireless communication includes means for receiving, by a UE, a system information broadcast message with a multimedia alert, means for automatically initiating, by the UE, a multimedia broadcast application in response to the multimedia alert, wherein the multimedia alert includes broadcast system information enabling the multimedia broadcast application to automatically tune into a streaming multimedia content, and means for processing, by the UE, the streaming multimedia content on the UE.

In an additional aspect of the disclosure, a computer-readable medium having program code recorded thereon. This program code includes code to receive, by a UE, a system information broadcast message with a multimedia alert, code to automatically initiate, by the UE, a multimedia broadcast application in response to the multimedia alert, wherein the multimedia alert includes broadcast system information enabling the multimedia broadcast application to automatically tune into a streaming multimedia content, and code to process, by the UE, the streaming multimedia content on the UE.

In an additional aspect of the disclosure, an apparatus includes at least one processor and a memory coupled to the processor. The processor is configured to receive, by a UE, a system information broadcast message with a multimedia alert, to automatically initiate, by the UE, a multimedia broadcast application in response to the multimedia alert, wherein the multimedia alert includes broadcast system information enabling the multimedia broadcast application to automatically tune into a streaming multimedia content, and to process, by the UE, the streaming multimedia content on the UE.

The foregoing has outlined rather broadly the features and technical advantages of the present application in order that the detailed description that follows may be better understood. Additional features and advantages will be described hereinafter which form the subject of the claims. It should be appreciated by those skilled in the art that the conception and specific aspect disclosed may be readily utilized as a basis for modifying or designing other structures for carrying out the same purposes of the present application. It should also be realized by those skilled in the art that such equivalent constructions do not depart from the spirit and scope of the present application and the appended claims. The novel features which are believed to be characteristic of aspects, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present claims.

### BRIEF DESCRIPTION OF THE DRAWINGS

FIG. 1 is a block diagram conceptually illustrating an example of a telecommunications system.

FIG. 2 is a block diagram conceptually illustrating an example of a down link frame structure in a telecommunications system.

FIG. 3 is a block diagram conceptually illustrating a design of a base station/eNB and a UE configured according to one aspect of the present disclosure.

FIG. 4 is a diagram of a signaling frame illustrating an example of symbol allocation for unicast and multicast signals.

FIG. 5 is a diagram illustrating MBMS over a Single Frequency Network (MBSFN) areas within an MBSFN service area.

FIG. 6 is a block diagram illustrating components of a wireless communication system for providing or supporting MBSFN service.

FIG. 7 is a block diagram illustrating a multimedia emergency broadcast system.

FIG. 8 is a block diagram illustrating example blocks executed to implement one aspect of the present disclosure.

FIGS. 9A-9F are block diagrams illustrating a UE configured to operate with a multimedia PWS alert system configured according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), CDMA2000, etc. UTRA includes Wideband CDMA (WCDMA) and other variants of CDMA. CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

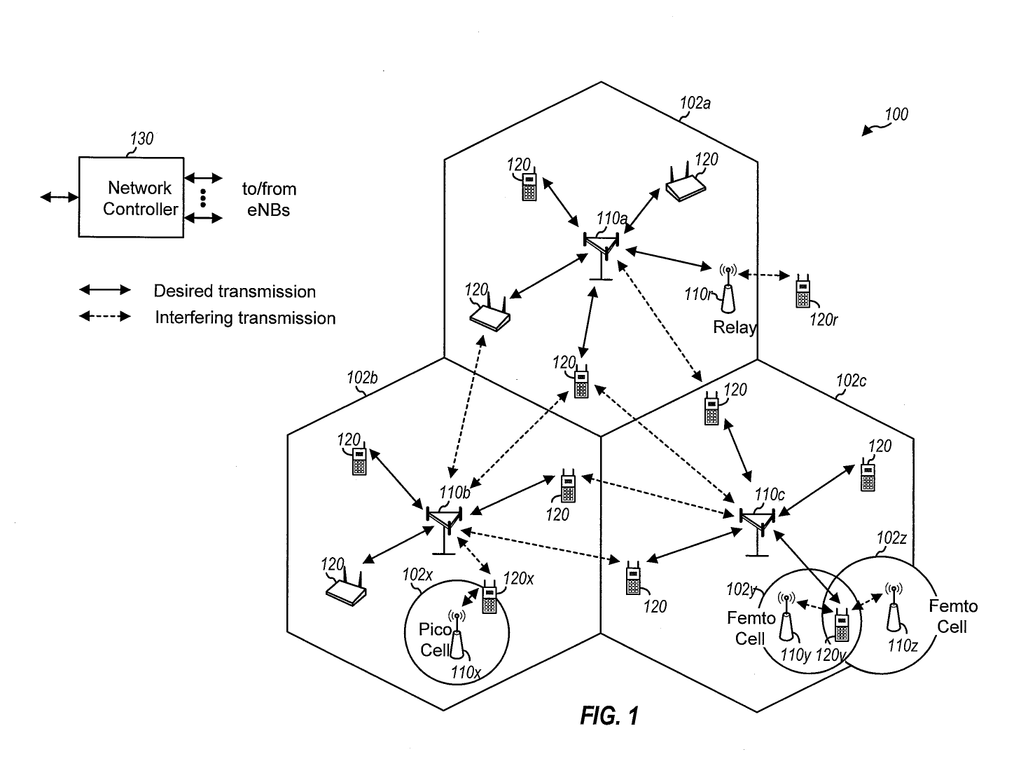

FIG. 1 shows a wireless communication network 100, which may be an LTE network. The wireless network 100 may include a number of eNBs 110 and other network entities. An eNB may be a station that communicates with the UEs and may also be referred to as a base station, a Node B, an access point, or other term. Each eNB 110a, 110b, 110c may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB. An eNB for a pico cell may be referred to as a pico eNB. An eNB for a femto cell may be referred to as a femto eNB or a home eNB (HNB). In the example shown in FIG. 1, the eNBs 110a, 110b and 110c may be macro eNBs for the macro cells 102a, 102b and 102c, respectively. The eNB 110x may be a pico eNB for a pico cell 102x, serving a UE 120x. The eNBs 110y and 110z may be femto eNBs for the femto cells 102y and 102z, respectively. An eNB may support one or multiple (e.g., three) cells.

The wireless network 100 may also include relay stations 110r. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with the eNB 110a and a UE 120r in order to facilitate communication between the eNB 110a and the UE 120r. A relay station may also be referred to as a relay eNB, a relay, etc.

The wireless network 100 may be a heterogeneous network that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 20 Watts) whereas pico eNBs, femto eNBs and relays may have a lower transmit power level (e.g., 1 Watt).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with the eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a smart phone, a tablet, or other mobile entities. A UE may be able to communicate with macro eNBs, pico eNBs, femto eNBs, relays, or other network entities. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz, and there may be 1, 2, 4, 8 or 16 subbands for system bandwidth of 1.25, 2.5, 5, 10 or 20 MHz, respectively.

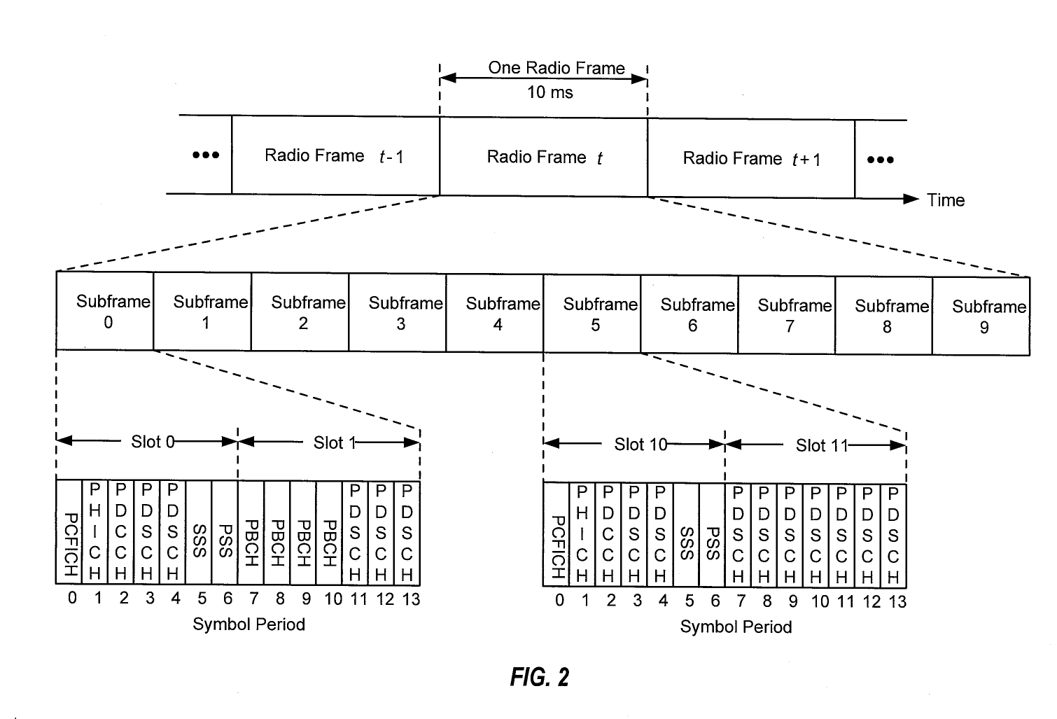

FIG. 2 shows a down link frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (CP), as shown in FIG. 2, or 6 symbol periods for an extended cyclic prefix. The normal CP and extended CP may be referred to herein as different CP types. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in only a portion of the first symbol period of each subframe, although depicted in the entire first symbol period in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNB may send a Physical HARQ Indicator Channel (PHICH) and a Physical Downlink Control Channel (PDCCH) in the first M symbol periods of each subframe (M=3 in FIG. 2). The PHICH may carry information to support hybrid automatic retransmission (HARQ). The PDCCH may carry information on resource allocation for UEs and control information for downlink channels. Although not shown in the first symbol period in FIG. 2, it is understood that the PDCCH and PHICH are also included in the first symbol period. Similarly, the PHICH and PDCCH are also both in the second and third symbol periods, although not shown that way in FIG. 2. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

A UE may be within the coverage of multiple eNBs. One of these eNBs may be selected to serve the UE. The serving eNB may be selected based on various criteria such as received power, path loss, signal-to-noise ratio (SNR), etc.

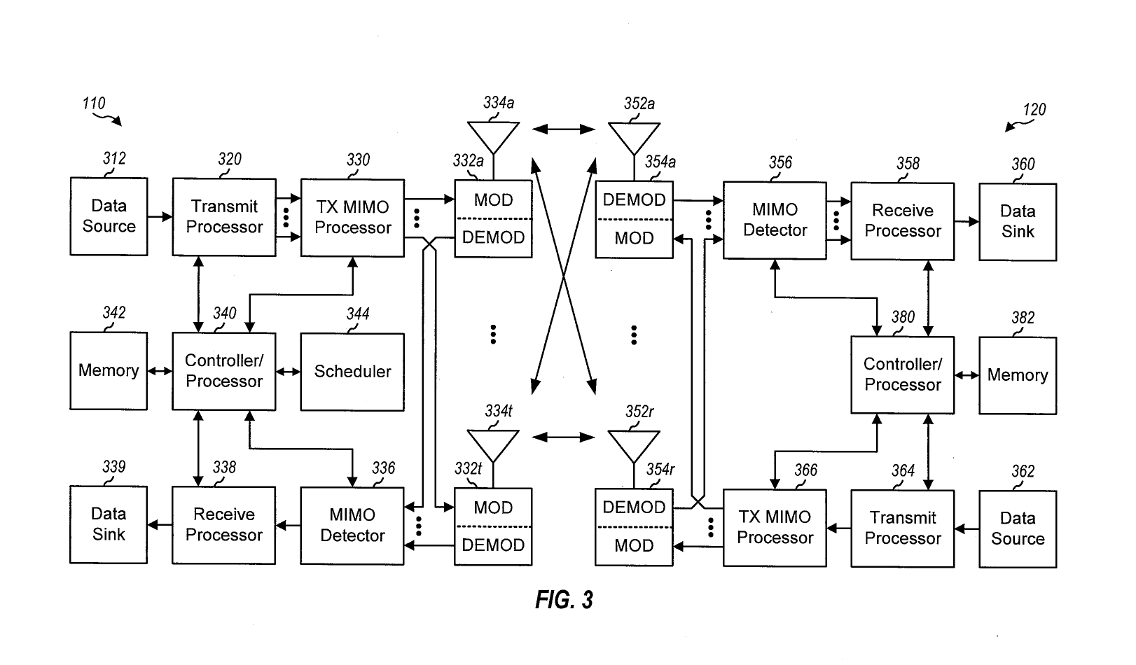

FIG. 3 shows a block diagram of a design of a base station/eNB 110 and a UE 120, which may be one of the base stations/eNBs and one of the UEs in FIG. 1. For a restricted association scenario, the base station 110 may be the macro eNB 110c in FIG. 1, and the UE 120 may be the UE 120y. The base station 110 may also be a base station of some other type. The base station 110 may be equipped with antennas 334a through 334t, and the UE 120 may be equipped with antennas 352a through 352r.

At the base station 110, a transmit processor 320 may receive data from a data source 312 and control information from a controller/processor 340. The control information may be for the PBCH, PCFICH, PHICH, PDCCH, etc. The data may be for the PDSCH, etc. The processor 320 may process (e.g., encode and symbol map) the data and control information to obtain data symbols and control symbols, respectively. The processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120, the antennas 352a through 352r may receive the downlink signals from the base station 110 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The processor 364 may also generate reference symbols for a reference signal. The symbols from the transmit processor 364 may be precoded by a TX MIMO processor 366 if applicable, further processed by the modulators 354a through 354r (e.g., for SC-FDM, etc.), and transmitted to the base station 110. At the base station 110, the uplink signals from the UE 120 may be received by the antennas 334, processed by the demodulators 332, detected by a MIMO detector 336 if applicable, and further processed by a receive processor 338 to obtain decoded data and control information sent by the UE 120. The processor 338 may provide the decoded data to a data sink 339 and the decoded control information to the controller/processor 340.

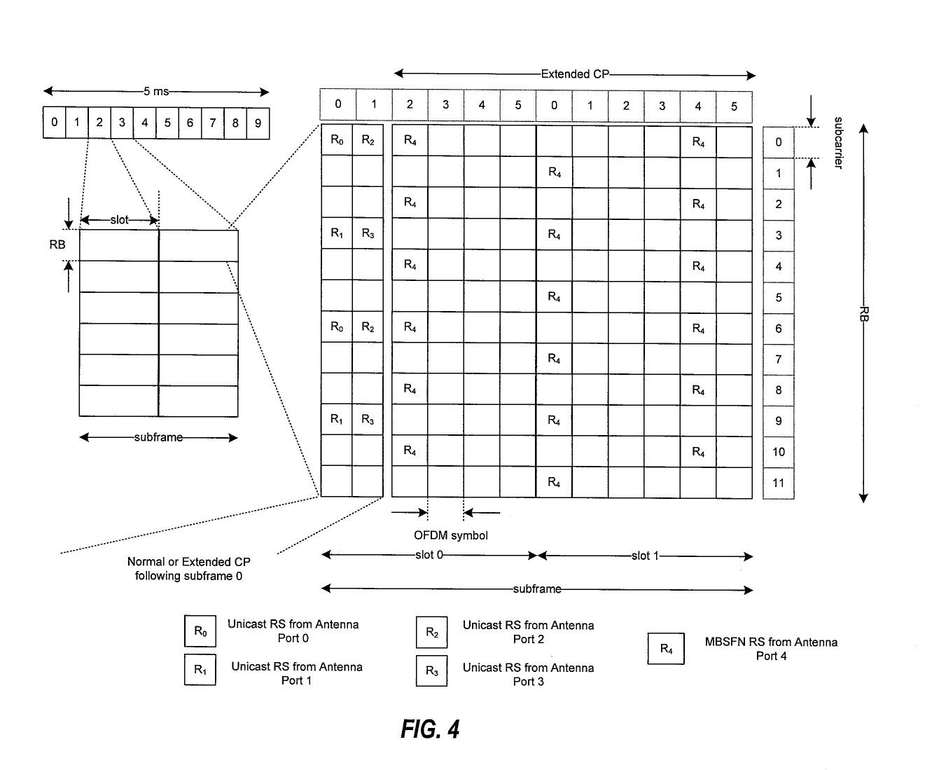

The controllers/processors 340 and 380 may direct the operation at the base station 110 and the UE 120, respectively. The processor 340 and/or other processors and modules at the base station 110 may perform or direct the execution of various processes for the techniques described herein. The processor 380 and/or other processors and modules at the UE 120 may also perform or direct the execution of the functional blocks illustrated in FIGS. 4 and 5, and/or other processes for the techniques described herein. The memories 342 and 382 may store data and program codes for the base station 110 and the UE 120, respectively. A scheduler 344 may schedule UEs for data transmission on the downlink and/or uplink.

In one configuration, the UE 120 for wireless communication includes means for detecting interference from an interfering base station during a connection mode of the UE, means for selecting a yielded resource of the interfering base station, means for obtaining an error rate of a physical downlink control channel on the yielded resource, and means, executable in response to the error rate exceeding a predetermined level, for declaring a radio link failure. In one aspect, the aforementioned means may be the processor(s), the controller/processor 380, the memory 382, the receive processor 358, the MIMO detector 356, the demodulators 354a, and the antennas 352a configured to perform the functions recited by the aforementioned means. In another aspect, the aforementioned means may be a module or any apparatus configured to perform the functions recited by the aforementioned means.

eMBMS and Unicast Signaling in Single Frequency Networks:

One technique to facilitate high bandwidth communication for multimedia has been single frequency network (SFN) operation. Particularly, Multimedia Broadcast Multicast Service (MBMS) and MBMS for LTE, also known as evolved MBMS (eMBMS) (including, for example, what has recently come to be known as multimedia broadcast single frequency network (MBSFN) in the LTE context), can utilize such SFN operation. SFNs utilize radio transmitters, such as, for example, eNBs, to communicate with subscriber UEs. Groups of eNBs can transmit information in a synchronized manner, so that signals reinforce one another rather than interfere with each other. In the context of eMBMS, the shared content is transmitted from multiple eNB's of a LTE network to multiple UEs. Therefore, within a given eMBMS area, a UE may receive eMBMS signals from any eNB(s) within radio range as part of the eMBMS service area or MBSFN area. However, to decode the eMBMS signal each UE receives Multicast Control Channel (MCCH) information from a serving eNB over a non-eMBMS channel. MCCH information changes from time to time and notification of changes is provided through another non-eMBMS channel, the PDCCH. Therefore, to decode eMBMS signals within a particular eMBMS area, each UE is served MCCH and PDCCH signals by one of the eNBs in the area.

In accordance with aspects of the subject of this disclosure, there is provided a wireless network (e.g., a 3GPP network) having features relating to single carrier optimization for eMBMS. eMBMS provides an efficient way to transmit shared content from an LTE network to multiple mobile entities, such as, for example, UEs.

With respect a physical layer (PHY) of eMBMS for LTE Frequency Division Duplex (FDD), the channel structure may comprise time division multiplexing (TDM) resource partitioning between eMBMS and unicast transmissions on mixed carriers, thereby allowing flexible and dynamic spectrum utilization. Currently, a subset of subframes (up to 60%), known as multimedia broadcast single frequency network (MBSFN) subframes, can be reserved for eMBMS transmission. As such current eMBMS design allows at most six out of ten subframes for eMBMS.

An example of subframe allocation for eMBMS is shown in FIG. 4, which shows an existing allocation of MBSFN reference signals on MBSFN subframes, for a single-carrier case. Components depicted in FIG. 4 correspond to those shown in FIG. 2, with FIG. 4 showing the individual subcarriers within each slot and resource block (RB). In 3GPP LTE, an RB spans 12 subcarriers over a slot duration of 0.5 ms, with each subcarrier having a bandwidth of 15 kHz together spanning 180 kHz per RB. Subframes may be allocated for unicast or eMBMS; for example in a sequence of subframes labeled 0, 1, 2, 3, 4, 5, 6, 7, 8, and 9, subframes 0, 4, 5, and 9 may be excluded from eMBMS in FDD. Also, subframes 0, 1, 5, and 6 may be excluded from eMBMS in time division duplex (TDD). More specifically, subframes 0, 4, 5, and 9 may be used for PSS/SSS/PBCH/paging/system information blocks (SIBs) and unicast service. Remaining subframes in the sequence, e.g., subframes 1, 2, 3, 6, 7, and 8 may be configured as eMBMS subframes.

With continued reference to FIG. 4, within each eMBMS subframe, the first 1 or 2 symbols may be used for unicast reference symbols (RSs) and control signaling. A CP length of the first 1 or 2 symbols may follow that of subframe 0. A transmission gap may occur between the first 1 or 2 symbols and the eMBMS symbols if the CP lengths are different. In related aspects, the overall eMBMS bandwidth utilization may be 42.5% considering RS overhead (e.g., 6 eMBMS subframes and 2 control symbols within each eMBMS subframe). Known techniques for providing MBSFN RSs and unicast RSs typically involve allocating the MBSFN RSs on MBSFN subframes (as shown in FIG. 4), and separately allocating unicast RSs on non-MBSFN subframes. More specifically, as FIG. 4 shows, the extended CP of the MBSFN subframe includes MBSFN RSs but not unicast RSs. The present technology is not limited to the particular frame allocation scheme illustrated by FIGS. 2 and 4, which are presented by way of example, and not by way of limitation. A multicast session or multicast broadcast as used herein may use any suitable frame allocation scheme.

eMBMS Service Areas:

FIG. 5 illustrates a system 500 including an MBMS service area 502 encompassing multiple MBSFN areas 504, 506, 508, which themselves include multiple cells or base stations 510. As used herein, an “MBMS service area” refers to a group of wireless transmission cells where a certain MBMS service is available. For example, a particular sports or other program may be broadcast by base stations within the MBMS service area at a particular time. The area where the particular program is broadcast defines the MBMS service area. The MBMS service area may be made up of one or more “MBSFN areas” as shown at 504, 506 and 508. As used herein, an MBSFN area refers to a group of cells (e.g., cells 510) currently broadcasting a particular program in a synchronized fashion using an MBSFN protocol. An “MBSFN synchronization area” refers to a group of cells that are interconnected and configured in a way such that they are capable of operating in a synchronized fashion to broadcast a particular program using an MBSFN protocol, regardless of whether or not they are currently doing so. Each eNB can belong to only one MBSFN synchronization area, on a given frequency layer. It is worth noting that an MBMS service area 502 may include one or more MBSFN synchronization areas (not shown). Conversely, an MBSFN synchronization area may include one or more MBSFN areas or MBMS service areas. Generally, an MBSFN area is made up of all, or a portion of, a single MBSFN synchronization area and is located within a single MBMS service area. Overlap between various MBSFN areas is supported, and a single eNB may belong to several different MBSFN areas. For example, up to 8 independent MCCHs may be configured in System Information Block (SIB) 13 to support membership in different MBSFN areas. An MBSFN Area Reserved Cell or Base Station is a cell/base station within a MBSFN Area that does not contribute to the MBSFN transmission, for example a cell near a MBSFN Synchronization Area boundary, or a cell that that is not needed for MBSFN transmission because of its location.

eMBMS System Components and Functions:

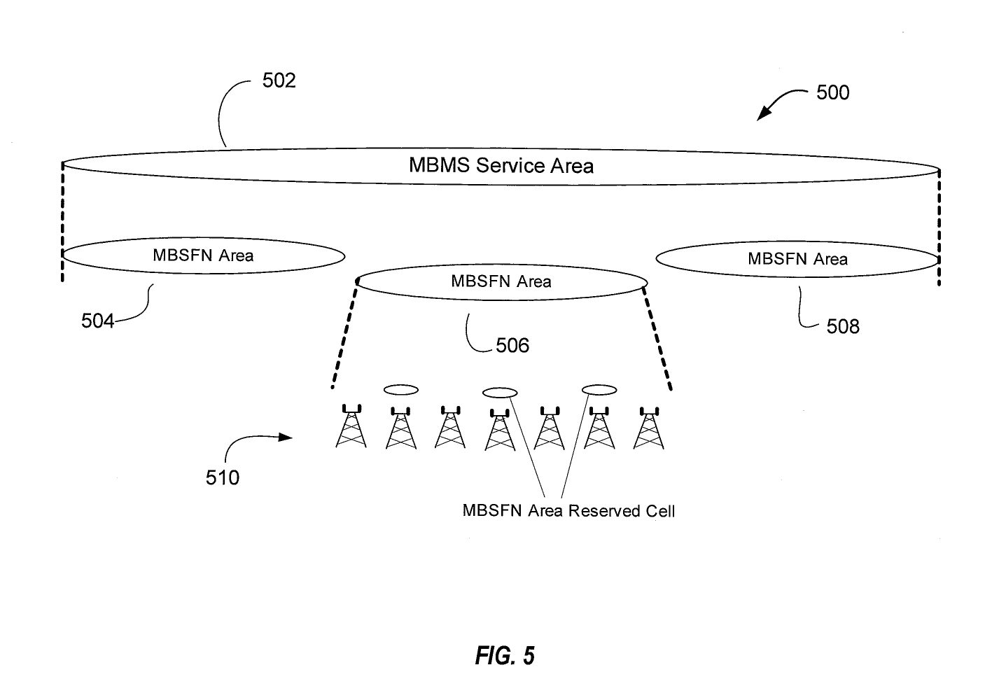

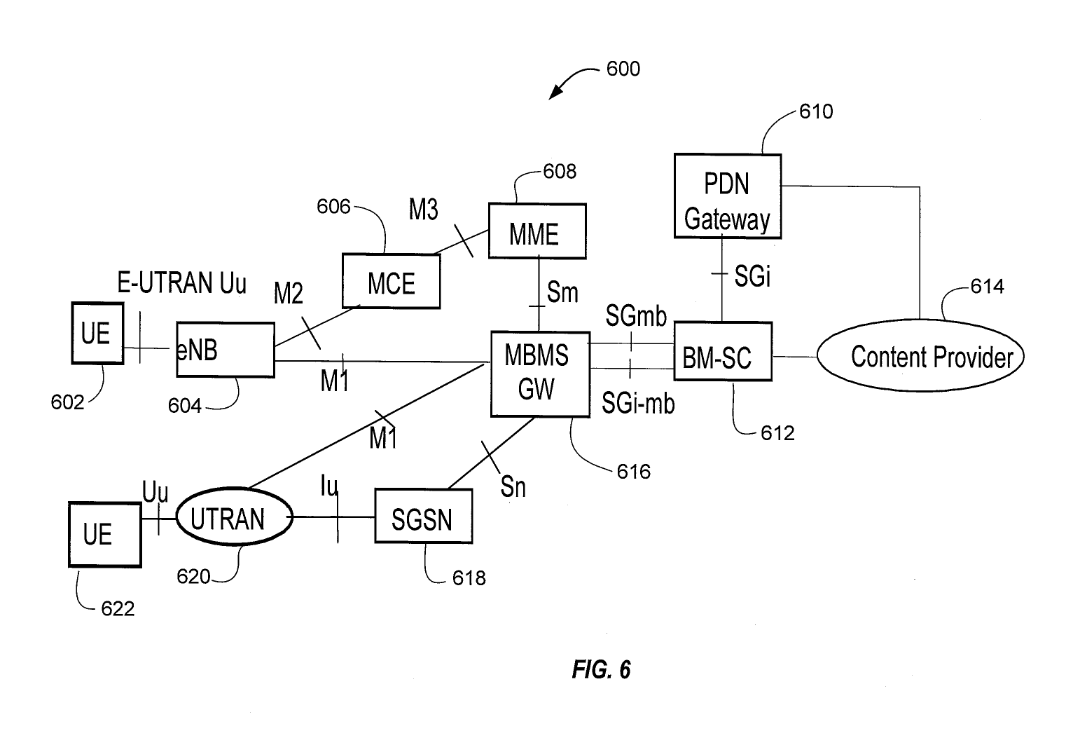

FIG. 6 illustrates functional entities of a wireless communication system 600 for providing or supporting MBSFN service. Regarding Quality of Service (QoS), the system 600 uses a Guaranteed Bit Rate (GBR) type MBMS bearer, wherein the Maximum Bit Rate (MBR) equals the GBR. These components are shown and described by way of example, and do not limit the inventive concepts described herein, which may be adopted to other architectures and functional distributions for delivering and controlling multicast transmissions.

The system 600 may include an MBMS Gate Way (MBMS GW) 616. The MBMS GW 616 controls Internet Protocol (IP) multicast distribution of MBMS user plane data to eNodeBs 604 via an M1 interface; one eNB 604 of many possible eNBs is shown. In addition, the MBMS GW controls IP multicast distribution of MBMS user plane data to UTRAN Radio Network Controllers (RNCs) 620 via an M1 interface; one UTRAN RNC 620 of many possible RNCs is shown. The M1 interface is associated to MBMS data (user plane) and makes use of IP for delivery of data packets. The eNB 604 may provide MBMS content to a user equipment (UE)/mobile entity 602 via an E-UTRAN Uu interface. The RNC 620 may provide MBMS content to a UE mobile entity 622 via a Uu interface. The MBMS GW 616 may further perform MBMS Session Control Signaling, for example MBMS session start and session stop, via the Mobility Management Entity (MME) 608 and Sm interface. The MBMS GW 616 may further provide an interface for entities using MBMS bearers through the SG-mb (user plane) reference point, and provide an interface for entities using MBMS bearers through the SGi-mb (control plane) reference point. The SG-mb Interface carries MBMS bearer service specific signaling. The SGi-mb interface is a user plane interface for MBMS data delivery. MBMS data delivery may be performed by IP unicast transmission, which may be a default mode, or by IP multicasting. The MBMS GW 616 may provide a control plane function for MBMS over UTRAN via a Serving General Packet Radio Service Support Node (SGSN) 618 and the Sn/Iu interfaces.

The system 600 may further include a Multicast Coordinating Entity (MCE) 606. The MCE 606 may perform an admission control function form MBMS content, and allocate time and frequency radio resources used by all eNBs in the MBSFN area for multi-cell MBMS transmissions using MBSFN operation. The MCE 606 may determine a radio configuration for an MBSFN Area, such as, for example, the modulation and coding scheme. The MCE 606 may schedule and control user plane transmission of MBMS content, and manage eMBMS service multiplexing, by determining which services are to be multiplexed in which Multicast Channel (MCH). The MCE 606 may participate in MBMS Session Control Signaling with the MME 608 through an M3 interface, and may provide a control plane interface M2 with the eNB 604.

The system 600 may further include a Broadcast-Multicast Service Center (BM-SC) 612 in communication with a content provider server 614. The BM-SC 612 may handle intake of multicast content from one or more sources such as the content provider 614, and provide other higher-level management functions as described below. These functions may include, for example, a membership function, including authorization and initiation of MBMS services for an identified UE. The BM-SC 612 may further perform MBMS session and transmission functions, scheduling of live broadcasts, and delivery, including MBMS and associated delivery functions. The BM-SC 612 may further provide service advertisement and description, such as advertising content available for multicast. A separate Packet Data Protocol (PDP) context may be used to carry control messages between UE and BM-SC. The BM-SC 612 may further provide security functions such as key management, manage charging of content providers according to parameters such as data volume and QoS, provide content synchronization for MBMS in UTRAN and in E-UTRAN for broadcast mode, and provide header compression for MBSFN data in UTRAN. The BM-SC 612 may indicate session start, update and stop to the MBMS-GW 616 including session attributes such as QoS and MBMS service area.

The system 600 may further include a Multicast Management Entity (MME) 608 in communication with the MCE 606 and MBMS-GW 608. The MME 608 may provide a control plane function for MBMS over E-UTRAN. In addition, the MME may provide the eNB 604, 620 with multicast related information defined by the MBMS-GW 616. An Sm interface between the MME 608 and the MBMS-GW 616 may be used to carry MBMS control signaling, for example, session start and stop signals.

The system 600 may further include a Packet Data Network (PDN) Gate Way (GW) 610, sometimes abbreviated as a P-GW. The P-GW 610 may provide an Evolved Packet System (EPS) bearer between the UE 602 and BM-SC 612 for signaling and/or user data. As such, the P-GW may receive Uniform Resource Locator (URL) based requests originating from UEs in association with IP addresses assigned to the UEs. The BM-SC 612 may also be linked to one or more content providers via the P-GW 610, which may communicate with the BM-SC 612 via an IP interface.

LTE supports the Emergency Alert Service using cell broadcasting. Current System Information Blocks (SIBs) defined in various radio access networks (RANs) can support emergency alerts through the Public Warning System (PWS). There are currently two general categories of emergency alert services: Earthquake and Tsunami Warning System (ETWS), which provides notifications of natural disasters, such as earthquakes and tsunamis, and Commercial Mobile Alert System (CMAS), designated for presidential, imminent threat, and child abduction emergency alerts. One goal of these Emergency Alert Services is to send emergency alert notifications to as many devices as possible at the earliest time possible in a reliable way.

The Emergency Alert Service in LTE provides a page that informs a UE within range of the base station of the emergency notification. A UE may read the paging while in idle state. Additionally, ETWS and/or CMAS-capable UEs may also read the paging in a connected state, such as RRC_CONNECTED, to check whether ETWS and/or CMAS notification is present or not. Such an ETWS/CMAS-capable UE would read the paging at least once every default paging cycle. The paging message includes an indication, whether an ETWS-Indication or a CMAS-Indication. The emergency notifications are provided in System Information Blocks (SIBs). SIB10 and SIB11 are assigned to ETWS, in which SIB10 contains the primary ETWS notification and SIB11 contains the secondary notification. CMAS notifications are contained in SIB12. In the event of an emergency, SIB1 carries the scheduling information for SIB10/11 (for ETWS) or SIB12 (for CMAS).

The emergency notification system begins with authorized emergency notification bodies that initiate a notification upon detection of an emergency. The emergency notification is provided into the cell broadcast system at a cell broadcast entity (CBE) and cell broadcast center (CBC). The notification is propagated into the LTE network through a CBC connection to a mobility management entity (MME). In an LTE network, the eNBs are grouped into target areas (identified by a target area identifier (TAID)), or logical emergency affected area (identified by emergency area identifier (EAID)). When the emergency notification is received at the MME, the MME broadcasts the emergency notifications to the eNBs included in the affected areas (TAIDs/EAIDs). The eNBs in affected areas then signal the emergency notifications to UEs in those areas. The eNB sends a paging message to notify the UEs of the emergency information (e.g., SIB changes). The UEs in idle or connected mode receive paging message during the paging monitoring periods. For example, a SIB-1 is sent periodically every 80-ms and provides schedule information for SIB-10, SIB-11 (for ETWS) and SIB-12 (for CMAS). The UEs would then use the schedule information to access the appropriate SIBs.

Current emergency notification services in LTE provide textual description of emergency events. Because the notifications defined in the SIBs are sent over a unicast channel (e.g., PDSCH), they tend to suffer from neighbor cell interference. To ensure that majority of users can receive such notification, the data rates over SIBs are rather limited. SIBs are sufficient for notification and small text data (e.g., approximately 140 text characters), but is not capable of carrying rich media or larger amounts of data (for example, maps for evacuations in emergency case, or graphic of warned area).

eMBMS may be used to deliver enhanced emergency content via broadcast benefitting from MBSFN gain. Use of eMBMS takes advantage of more bandwidth to deliver rich media content. MBSFN transmission also experiences significantly reduced downlink interference compared to the unicast transmission of SIBs. Moreover, higher receive SNR with MBSFN allows for rich media content to be transmitted to multiple UEs. With the increased bandwidth, eMBMS transmissions may include images, additional text, news or emergency agency audio/video clips, emergency metadata (e.g., EPG for emergency eMBMS services), and the like. Moreover, with increased bandwidth, eMBMS transmissions may provide emergency related streaming content, which may include live coverage of affected areas, maps, video directions, and the like.

Various aspects of the present disclosure are directed to providing users multimedia PWS alerts. The integration of eMBMS with existing PWS enabling a multimedia public warning systems has been defined as multimedia broadcast supplementing PWS (MBSP) for 3GPP. Currently, PWS alerts are contained within the cell broadcasts of various system information blocks (SIBs), such as SIB11, SIB12, and the like. The alphanumeric text of the PWS alert is carried within the cell broadcast in the SIBs, which limits the size of the alert information to a maximum of approximately 140 characters. Thus, instead of only receiving a 140 character text notification stating the emergency, a multimedia PWS alert may allow a recipient device to receive a text notification and multimedia data (e.g., image, video, audio, or any combination thereof) of information related to the particular emergency with limited delay. Moreover, by providing a minimum of eMBMS system information within the cell broadcast of the PWS alert, the user would not be required to enter any additional information in such MB SP systems in order to receive the multimedia content.

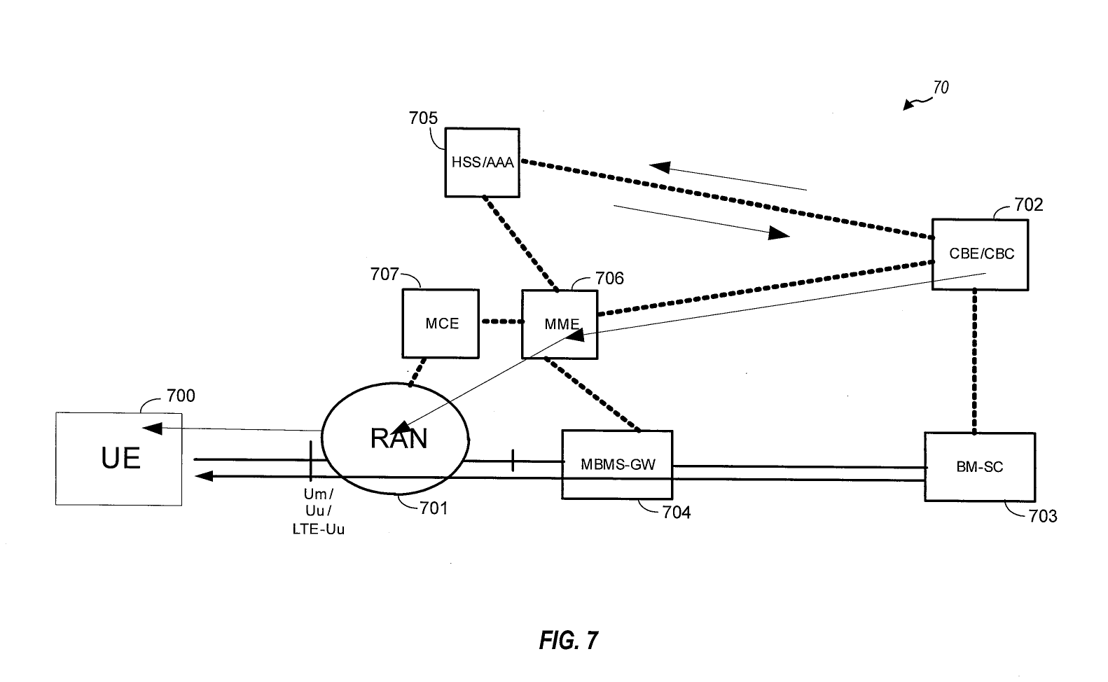

FIG. 7 is a block diagram illustrating a multimedia emergency broadcast system 70 configured according to one aspect of the present disclosure. In managing a broadcast-multicast emergency service such as emergency broadcast system 70, an emergency authority (not shown) may initially establish a service and a mechanism to provide an emergency alert to the wireless network through cell broadcast entity (CBE)/cell broadcast center (CBC) 702. CBE/CBC 702 acts as the interface between the emergency authority and the wireless networks. In interfacing the broadcast-multicast emergency service to an LTE network, CBE/CBC 702 maintains a connection to mobility management entity (MME) 706. The MBMS system of the LTE network is managed by MME 706 with multicell/multicast coordinating entity (MCE) 707, BM-SC 703, and MBMS-GW 704.

When an emergency situation arises, CBE/CBC 702 issues an emergency notification and transmits the notification to MME 706. MME 706 determines the specific target area identifier (TAID) or emergency area identifier (EAID) that the emergency notification should be directed and selects the appropriate locations, such as RAN 701. RAN 701 may include various base stations and access nodes in a specific location corresponding to the TAID/EAID. An emergency notification is then transmitted which is received by UE 700 through a cell broadcast contained within a system information block (SIB) message. The emergency broadcast content is transmitted from BM-SC 703. An MBMS session may be established at BM-SC 703, which would also update the USD identifier for accessing the eMBMS emergency service session via normal operations & management (O&M) functionality. Alternatively, the eMBMS session may be triggered by CBE/CBC 702.

The emergency notification may be received in a cell broadcast of the various associated SIBs, such as SIB10/11/12, depending on the type of emergency. The cell broadcast with the emergency notification within the SIB message includes at least a temporary mobile group identity (TMGI) corresponding to the emergency multimedia content. The TMGI contained within the cell broadcast would allow UE 700 to automatically access the multimedia content without further user interaction.

A TMGI is a temporary identifier assigned by the BM-SC 703, which identifier an MBMS bearer service. The MBMS service area element defines the area of the UMTS network in which data of an MBMS bearer service needs to be distributed. The MBMS bearer service, then, forms an efficient distribution tree from the BM-SC 703 down to the radio access networks in which interested receivers, such as UE 700, are located. In various additional aspects, the cell broadcast with the emergency alert may also include any combination of additional eMBMS system information, such as: a session description protocol, including an internet protocol (IP) address, user datagram protocol (UDP) port, FLUTE configuration, and the like; media presentation description (MPD), including the DASH media presentation description file specifying how audio/video media is formatted; and optional service area identifiers (SAIs) if the emergency content is broadcasted on neighboring frequencies.

On receipt of the emergency notification in the cell broadcast contained within the SIB message, the eMBMS application on UE 700 would be automatically triggered. Using the appropriate TMGI, the eMBMS application of UE 700 tunes to access the eMBMS emergency service content transmitted by BM-SC 703 through MBMS-GW 704. Other information used for the transmission can be preconfigured or inferred (e.g. reception reporting, file repair, codec use, etc.). The eMBMS emergency service content streaming onto the eMBMS channel would then provide UE 700 with the emergency content, e.g., news, map figure, photo, video clip file, video streaming, or the like.

In alternative implementations as illustrated in FIG. 7, prior to an emergency eMBMS service being accessed by UE 700, UE 700 may be registered with the service. Subscriber information would be requested at CBE/CBC 702 from home subscriber server (HSS)/authentication, authorization, and accounting (AAA) server 705, which would respond with the available subscriber information including service area, eMBMS, and the like.

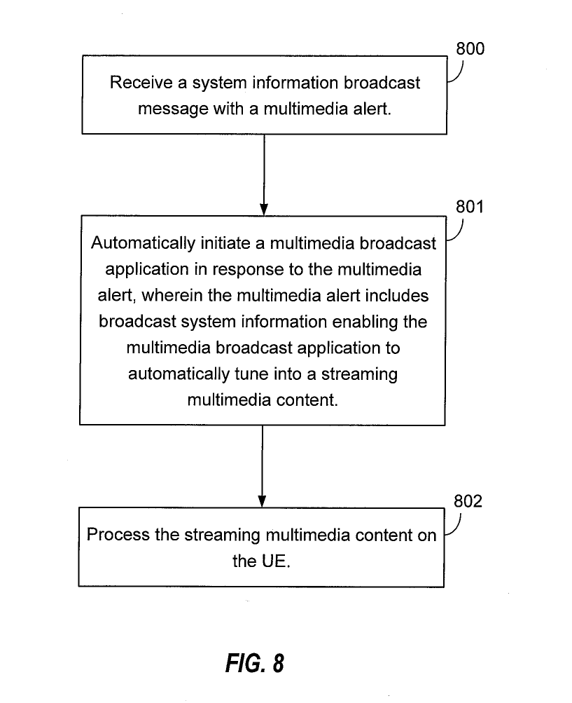

FIG. 8 is a block diagram illustrating example blocks executed to implement one aspect of the present disclosure. At block 800, a UE receivers a system information broadcast message including a multimedia alert. For example the multimedia alert may be a cell broadcast with the multimedia PWS alert contained within a SIB message, such as SIBs 10/11/12.

At block 801, in response to the multimedia alert, the UE automatically initiates a multimedia broadcast application which uses broadcast system information provided in the multimedia alert to automatically tune the UE into streaming multimedia content associated with the alert. For example, the cell broadcast with the multimedia PWS alert may include a TMGI that the eMBMS application on the UE can use to tune the UE into the eMBMS channel that is transmitting the emergency multimedia content. In additional example aspects, the cell broadcast with the multimedia PWS alert may also include a variety of broadcast system information such as one or more of an IP address, UDP port, FLUTE configuration, MPD, any optional SAIs for neighboring frequencies, and the like.

At block 802, the UE, once tuned to the streaming multimedia content may process the content. Processing the streaming multimedia content may include providing a notification to the user of the UE of the incoming content, providing a prompt to view the content or simply playing the content automatically on the UE display or user input/output (I/O) components (display, speaker, light, or other such component or I/O component in combination with a UE sensor, such as an accelerometer, thermometer, barometer, photodetector, and the like). The initial processing at the UE may also include issuing an alert prompt, such as an audible tone, visual flash of light or activation of a display screen, a haptic response, or any combination thereof.

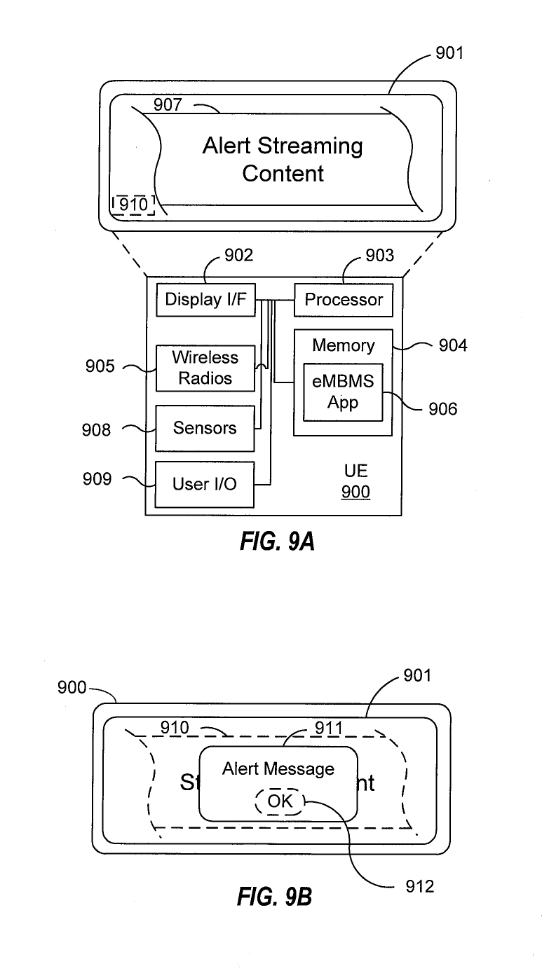

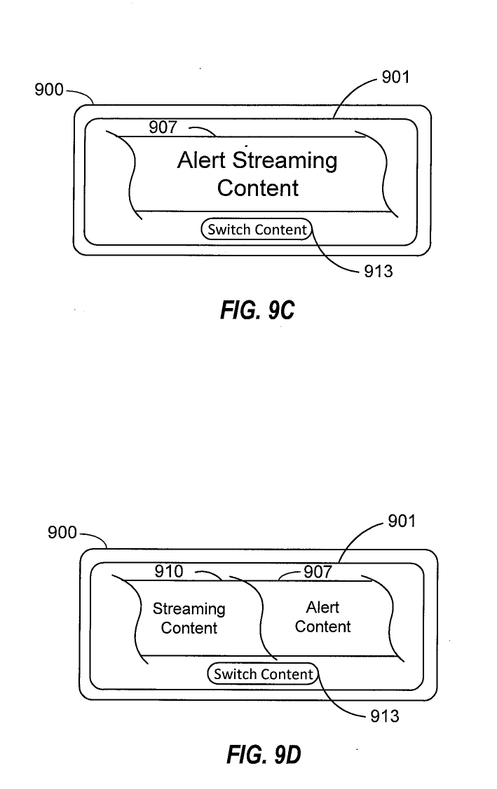

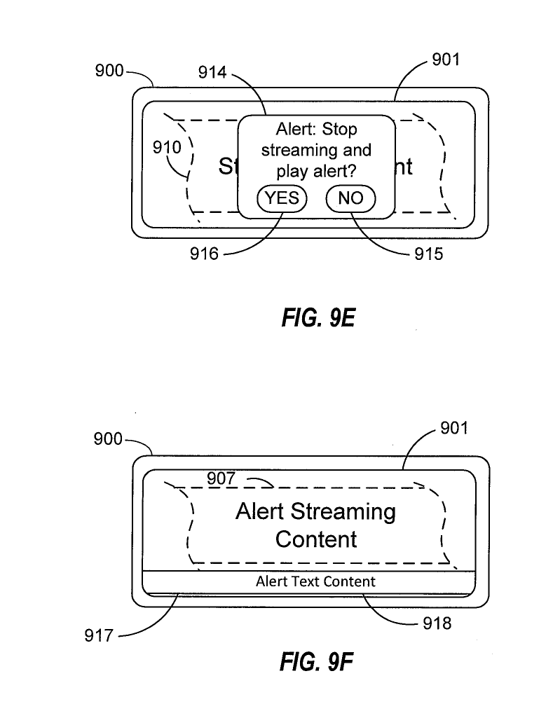

FIGS. 9A-9F are block diagrams illustrating a UE 900 configured to operate with a multimedia PWS alert system configured according to one aspect of the present disclosure. UE 900 includes a display 901 operated by display interface 902 under control of processor 903. Processor 103 may be a single processor or multiple processors, including multiple cores within the same processor chip. Wireless communications for UE 900 are facilitated through wireless radios 905 under control of processor 903. UE transmits and receives various RF signals through wireless radios 905. UE 900 also includes user I/O components 909, which may include a touch sensor for direct touches onto display 901 or other various physical switches, buttons, lights, and/or speakers built into UE 900. UE 900 also includes various sensors 908, which may include an accelerometer, thermometer, barometer, microphone, photo or light sensor, and the like. Communications with user I/O components 909 and sensors 908 are controlled and processed by processor 903. UE 900 also includes memory 904, which stores various applications and logic that provide the feature and functionalities of UE 900 when executed by processor 903. For example, memory 904 includes eMBMS application 906, which provide an operating environment, when executed by processor 903, that allows UE 900 to interface with the eMBMS broadcast system of a wireless network with which UE 900 is communicating.

In one aspect of the present disclosure, no other user interface activity is present on UE 900 when a multimedia PWS alert arrives. A SIB message with a multimedia alert is received over wireless radios 905. Using the eMBMS system information included in the cell broadcast within the SIB message would enable UE 900 to initiate eMBMS application 906 and tune into the appropriate broadcast channel to access the multimedia alert content seamlessly. Alert streaming content 907 would then be displayed on display 901 to the user. Additional intelligence may be added to eMBMS application 906 to present a small pop-up/alert (audio/visual/haptic) to indicate the presence of multimedia PWS alerts. For example, in FIG. 9B, and alert pop-up 911 is presented to the user. In alternative aspects, an acknowledgment option 912 is presented to the user to acknowledge the multimedia PWS alert, which would then being display of the alert content when acknowledged. eMBMS application 906 may automatically tune into the broadcast alerts and begin listening to the multimedia PWS alerts, e.g., alert streaming content 907 (FIG. 9A), after processing the broadcast system information, such as a TMGI, IP address, or the like, included in the SIB message and without user intervention.

In another aspect of the present disclosure, a multimedia PWS alert arrives while other applications or services are on-going and utilizing the user interface of the UE. In such aspects, the active application or service, streaming content 910 (FIG. 9A) may be paused and sent to background processing, either via minimizing the content view to a corner of the screen, as illustrated in FIG. 9A, or minimizing without any active screen presence, as illustrated in FIG. 9F. Alternatively, streaming content 910 may be terminated leaving display 901 free to display the alert streaming content 907 once tuned in. The multimedia PWS content may then be overlaid on display 901.

Additionally, when pausing the active application or service, streaming content 910, the user may be able to manually switch between the multimedia PWS content, alert streaming content 907, and other active services via shuffling utilities that toggle between the active user interface contents on display 901, such as by activating and pausing streaming content 910 and the other active applications or services using switch content button 913, as illustrated in FIGS. 9C and 9D.

In additional aspects of the present disclosure, other active eMBMS broadcast services, streaming content 910, are actively being streamed when a multimedia PWS alert arrives. In such aspects, eMBMS application 907 would allow for multi-view access by screen sharing the concurrent streaming of alert streaming content 907 with any other broadcast content, such as streaming content 910, as illustrated in FIG. 9D. The concurrent streaming allows streaming content 910 to continue playing on one side of display 901, while alert streaming content 907 is displayed on the other side of display 901. In such aspects, audio for only one of the streaming contents may be active at a given time. In such aspects, switch content button 913 may be available to a user to toggle between the active audios of alert streaming content 907 and any other active broadcast content, such as streaming content 910.

In additional aspects with existing eMBMS streaming content, streaming content 910, a single session may be given precedence, such that, on the arrival of a multimedia PWS alert any actively streaming eMBMS services may be stopped or paused. For example, as illustrated in FIG. 9C, when the multimedia PWS alert arrives and eMBMS application 907 uses the broadcast system information in the alert to tune UE 900 into the alert broadcast channel, UE 900 is already receiving broadcast services of streaming content 910 (not shown in FIG. 9C). Memory 904 includes a priority list that indicates PWS alerts and content have priority over other types of broadcast content. Accordingly, UE 900 pauses streaming content 910 and sends it to the background while displaying alert streaming content 907. Switch content button 913 may then be used to toggle between the available broadcast streaming services, such as paused streaming content 910 and alert streaming content 907.

Additional aspects of the present disclosure may also provide for an interface option to be presented to a user to ignore the multimedia PWS alert. As illustrated in FIG. 9E, an alert pop-up 914 is displayed on display 901 to a user when a multimedia PWS alert arrives while streaming content 910 is displayed in the background. Alert pop-up 914 includes an option to play the multimedia alert content, play button 916, or to ignore the multimedia alert content, ignore button 915. This option to ignore the multimedia PWS alerts may be implemented after the legacy primary/secondary notification. The user would simply choose not to select or tune to the multimedia PWS alerts though the broadcast system information provided in the cell broadcast of the SIB message containing the alert. This can be achieved by predefined user settings or by allowing the end user the flexibility to return back to the home screen or to other current activity after receiving the PWS SIBs.

Additional aspects of the present disclosure may provide capabilities to the mobile device of differentiating between legacy broadcast alerts in SIB messages and the enhanced multimedia PWS messages containing the broadcast system information. In such aspects, this differentiation can be conveyed by emitting different sounds or adding an audible signal indicating availability of the additional multimedia information. Additionally, different vibrational alerts may be assigned to the reception of enhanced cell broadcasts in the SIB messages containing multimedia PWS configuration. For example, as illustrated in FIG. 9A, UE 900 includes sensors 908 and user I/O components 909. When a legacy alert arrives, the UE 900 may activate a first audible signal from one of user I/O components 909. When an enhanced alert arrives, UE 900 may activate another audible signal or any combination of audible signal, visual signal, or haptic signal using a combination of components among sensors 908 and user I/O components 909. For example, upon arrival of a multimedia PWS alert, eMBMS application may trigger UE 900 to activate a microphone, camera, and thermometer from sensors 908 to determine that UE 900 is located in a user's pocket, based on the determination of where UE 900 is located, UE 900 then triggers vibration motors and the speaker of I/O components 909 to vibrate and may an audible signal from UE 900 notifying the user of the multimedia PWS alert.

Various additional aspects of the present disclosure may provide for streaming and downloading of multimedia PWS alerts. For streaming multimedia PWS alerts, eMBMS application 906 (FIG. 9A) may automatically tune wireless radios 905 into the broadcast alert and begin viewing or listening to the multimedia PWS content, alert streaming content 907, after processing the broadcast system information included in the cell broadcast of the SIB message with the alert. eMBMS application 906 may, thus, tune to and begin playing alert streaming content 907 without user intervention.

For download multimedia PWS alerts, in which the media associated with the alert content is fully downloaded to UE 900 for non-streaming play, eMBMS application 906 may elect to display PWS textual notification 918 (FIG. 9F) on text display banner 917, while downloading the multimedia PWS content. Alternatively, the application may hold PWS textual notification 918 until all PWS content has been downloaded, after processing the broadcast system information included in the cell broadcast of the SIB message with the alert. eMBMS application 906 would then display both PWS textual notification 918 on text display banner 917, while alert streaming content 907 is presented on display 907. The decision whether to immediately begin streaming, to display the textual notification first, or holding all PWS content until the multimedia content has been downloaded may be influenced by the stated size of the multimedia content, and by the allocated eMBMS bandwidth.

In additional aspects of the present disclosure, a multimedia PWS notification may contain a textual component, such as PWS textual notification 918. In such aspects, this textual component may be included as a supplement to the initial PWS notification, for example, alert pop-up 911 (FIG. 9B) may be presented on display 901 when the cell broadcast of the SIB message with the alert arrives, and then display PWS textual notification 918 on text display banner 917 when the textual component of the multimedia PWS notification is presented. When both multimedia and text components make up a PWS notification, both notifications may be displayed to the user.

A textual component of a multimedia PWS notification may also be included as an expanded replacement to the initial PWS notification. Alternatively, it may be included as a copy of the initial PWS notification. In such aspects, there may be no need to display the original PWS notification if, as described above, all notifications are being held until all of the multimedia PWS content has been downloaded.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and process steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. A computer-readable storage medium may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, non-transitory connections may properly be included within the definition of computer-readable medium. For example, if the instructions are transmitted from a website, server, or other remote source using a coaxial cable, fiber optic cable, twisted pair, or digital subscriber line (DSL), then the coaxial cable, fiber optic cable, twisted pair, or DSL are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
receiving, by a user equipment (UE), a system information broadcast message with a multimedia alert;
automatically initiating, by the UE, a multimedia broadcast application in response to the multimedia alert, wherein the multimedia alert includes broadcast system information enabling the multimedia broadcast application to automatically tune into a streaming multimedia content; and
processing, by the UE, the streaming multimedia content on the UE.

2. The method of claim 1, wherein the system information includes a temporary mobile group identity (TMGI) associated with the streaming multimedia content and zero or more of:
a session description protocol;
an internet protocol (IP) address;
a user datagram protocol (UDP) port,
a file delivery over unidirectional transport (FLUTE) configuration;
a media presentation description (MPD);
a dynamic adaptive streaming using hypertext transport protocol (DASH) media presentation description file; or
one or more service area identifiers (SAIs).

3. The method of claim 1, further including:
presenting, by the UE, a prompt on the display to the user, wherein the prompt indicates the presence of the streaming multimedia content, wherein the prompt includes one or more of:
a visual indicator;
a video;
an audio signal;
a haptic response; or
any combination thereof.

4. The method of claim 3, wherein the prompt provides an option for the user to ignore the streaming multimedia content.

5. The method of claim 1, wherein the system information broadcast message is received during an active application or service on the display of the UE, the method further including:
pausing the active application or service in response to receiving the system information broadcast message, wherein the paused active application or service is one of:
minimized to a minimized portion of the display; or
removed to a background process.

6. The method of claim 5, further including:
receiving, at the UE, input from a user, wherein the input allows the display to toggle between the paused active application or service and the streaming multimedia content.

7. The method of claim 1, wherein the system information broadcast message is received during an active prior streaming multimedia content on the display of the UE, wherein the displaying the streaming multimedia content on the display includes displaying the streaming multimedia content on a portion of the display while the active prior streaming multimedia content is displayed on the other portion of the display.

8. The method of claim 7, further including:
receiving, at the UE, input from a user, wherein the input allows the UE to toggle between the streaming multimedia content or active prior multimedia streaming content.

9. The method of claim 1, wherein the system information broadcast message is received during an active prior streaming multimedia content on the display of the UE, wherein the displaying includes displaying the streaming multimedia content or the active prior streaming multimedia content according to a predetermined priority.

10. The method of claim 1, further including:
presenting, by the UE, a notification to the user of availability of the streaming multimedia content prior to the displaying.

11. The method of claim 1, wherein the streaming multimedia content includes a textual component and a multimedia component.

12. The method of claim 11, further including one of:
displaying, by the UE, the textual component while downloading the multimedia component to the UE; or
displaying, by the UE, the textual component and the multimedia component only after downloading the multimedia component to the UE.

13. The method of claim 11, wherein the textual component is included as one of:
a supplement to notification of the streaming multimedia content;
an expanded replacement to notification of the streaming multimedia content; and
a copy of the notification of the streaming multimedia content.

14. An apparatus configured for wireless communication, comprising:
means for receiving, by a user equipment (UE), a system information broadcast message with a multimedia alert;
means for automatically initiating, by the UE, a multimedia broadcast application in response to the multimedia alert, wherein the multimedia alert includes broadcast system information enabling the multimedia broadcast application to automatically tune into a streaming multimedia content; and
means for processing, by the UE, the streaming multimedia content on the UE.

15. The apparatus of claim 14, wherein the system information includes a temporary mobile group identity (TMGI) associated with the streaming multimedia content and zero or more of:
a session description protocol;
an internet protocol (IP) address;
a user datagram protocol (UDP) port,
a file delivery over unidirectional transport (FLUTE) configuration;
a media presentation description (MPD);
a dynamic adaptive streaming using hypertext transport protocol (DASH) media presentation description file; or
one or more service area identifiers (SAIs).

16. A non-transitory computer-readable medium having program code recorded thereon, the program code including:
program code for causing a computer to receive, by a user equipment (UE), a system information broadcast message with a multimedia alert;
program code for causing the computer to automatically initiate, by the UE, a multimedia broadcast application in response to the multimedia alert, wherein the multimedia alert includes broadcast system information enabling the multimedia broadcast application to automatically tune into a streaming multimedia content; and
program code for causing the computer to process, by the UE, the streaming multimedia content on the UE.

17. The apparatus of claim 16, wherein the system information includes a temporary mobile group identity (TMGI) associated with the streaming multimedia content and zero or more of:
a session description protocol;
an internet protocol (IP) address;
a user datagram protocol (UDP) port,
a file delivery over unidirectional transport (FLUTE) configuration;
a media presentation description (MPD);
a dynamic adaptive streaming using hypertext transport protocol (DASH) media presentation description file;
one or more service area identifiers (SAIs).

18. An apparatus configured for wireless communication, the apparatus comprising:
at least one processor; and
a memory coupled to the at least one processor,
wherein the at least one processor is configured:
to receive, by a user equipment (UE), a system information broadcast message with a multimedia alert;
to automatically initiate, by the UE, a multimedia broadcast application in response to the multimedia alert, wherein the multimedia alert includes broadcast system information enabling the multimedia broadcast application to automatically tune into a streaming multimedia content; and
to process, by the UE, the streaming multimedia content on the UE.

19. The apparatus of claim 18, wherein the system information includes a temporary mobile group identity (TMGI) associated with the streaming multimedia content and zero or more of:
a session description protocol;
an internet protocol (IP) address;
a user datagram protocol (UDP) port,
a file delivery over unidirectional transport (FLUTE) configuration;
a media presentation description (MPD);
a dynamic adaptive streaming using hypertext transport protocol (DASH) media presentation description file; or
one or more service area identifiers (SAIs).

20. The apparatus of claim 18, further including configuration of the at least one processor to present, by the UE, a prompt on the display to the user, wherein the prompt indicates the presence of the streaming multimedia content, wherein the prompt includes one or more of:
a visual indicator;
a video;
an audio signal;
a haptic response; or
any combination thereof.

21. The apparatus of claim 20, wherein the prompt provides an option for the user to ignore the streaming multimedia content.

22. The apparatus of claim 18, wherein the system information broadcast message is received during an active application or service on the display of the UE, the apparatus further including configuration of the at least one processor to pause the active application or service in response to receiving the system information broadcast message, wherein the paused active application or service is one of:
minimized to a minimized portion of the display; or
removed to a background process.

23. The apparatus of claim 22, further including configuration of the at least one processor to receive, at the UE, input from a user, wherein the input allows the display to toggle between the paused active application or service and the streaming multimedia content.

24. The apparatus of claim 18, wherein the system information broadcast message is received during an active prior streaming multimedia content on the display of the UE, wherein the configuration of the at least one processor to display the streaming multimedia content on the display includes configuration to display the streaming multimedia content on a portion of the display while the active prior streaming multimedia content is displayed on the other portion of the display.

25. The apparatus of claim 24, further including configuration of the at least one processor to receive, at the UE, input from a user, wherein the input allows the UE to toggle between the streaming multimedia content or active prior multimedia streaming content.

26. The apparatus of claim 18, wherein the system information broadcast message is received during an active prior streaming multimedia content on the display of the UE, wherein the configuration of the at least one processor to display includes configuration to display the streaming multimedia content or the active prior streaming multimedia content according to a predetermined priority.

27. The apparatus of claim 18, further including configuration of the at least one processor to present, by the UE, a notification to the user of availability of the streaming multimedia content prior to execution of the configuration of the at least one processor to display.

28. The apparatus of claim 18, wherein the streaming multimedia content includes a textual component and a multimedia component.

29. The apparatus of claim 28, further including configuration of the at least one processor to one of:
display, by the UE, the textual component while downloading the multimedia component to the UE; or
display, by the UE, the textual component and the multimedia component only after downloading the multimedia component to the UE.

30. The apparatus of claim 28, wherein the textual component is included as one of:
a supplement to notification of the streaming multimedia content;
an expanded replacement to notification of the streaming multimedia content; and
a copy of the notification of the streaming multimedia content.
